(19) United States
(12) Patent Application Publication
(10) Pub. No.: US 2019/0068653 A1
(43) Pub. Date: Feb. 28, 2019

(54) MEDIA BYPASS

(71) Applicant: Metaswitch Networks Ltd., Enfield (GB)

(72) Inventor: Oliver CARTER, Hertford (GB)

(21) Appl. No.: 16/118,241

(22) Filed: Aug. 30, 2018

(30) Foreign Application Priority Data
Aug. 31, 2017 (GB) 1713980.9

(51) Int. Cl. H04L 29/06; H04L 29/08

(52) U.S. Cl. CPC H04L 65/1036; H04L 65/105; H04L 65/1063; H04L 65/1006; H04L 67/147; H04L 63/02; H04L 65/1069

(57) ABSTRACT

Measures to control telecommunications network equipment are provided. Signalling associated with establishment of a media communications session involving first and second endpoints is received. A first endpoint identifier associated with the first endpoint and a second endpoint identifier associated with the second endpoint are identified based on the signalling. It is determined whether or not to attempt media bypass between the first and second endpoints based on a comparison involving a first portion of the first endpoint identifier and a second portion of the second endpoint identifier. In response to determining that media bypass is to be attempted between the first and second endpoints, an attempt is made to cause media data for the media session to be communicated directly between the first and second endpoints.

### CROSS-REFERENCE TO RELATED APPLICATIONS

This application claims the benefit under 35 U.S.C. § 119(a) and 37 CFR § 1.55 to UK patent application no. GB1713980.9, filed on Aug. 31, 2017, the entire content of which is incorporated herein by reference.

### BACKGROUND OF THE INVENTION

### Field of the Invention

The present disclosure relates to media bypass.

### Description of the Related Technology

Media bypass is a known technique that enables endpoints in a telecommunications network to communicate media data directly with each other, rather than via a media relay, for example a session border controller (SBC). Media bypass can reduce the load on the access network between the endpoints and the media relay compared to the media data being communicated indirectly via the media relay. Media bypass may also enable improved call quality compared to indirect media data communication, for example in terms of error reduction, latency reduction and/or jitter reduction.

### SUMMARY

According to a first aspect of the present invention, there is provided a method of controlling telecommunications network equipment, the method comprising:
receiving signalling associated with establishment of a media communications session involving first and second endpoints;
identifying a first endpoint identifier associated with the first endpoint and a second endpoint identifier associated with the second endpoint based on the signalling;
determining whether or not to attempt media bypass between the first and second endpoints based on a comparison involving a first portion of the first endpoint identifier and a second portion of the second endpoint identifier; and
in response to determining that media bypass is to be attempted between the first and second endpoints, attempting to cause media data for the media session to be communicated directly between the first and second endpoints.

According to a second aspect of the present invention, there is provided a method comprising determining, at telecommunications network equipment, whether or not to attempt media bypass between first and second endpoints by comparing part of an IP address of the first endpoint to a corresponding part of an IP address of the second endpoint.

According to a third aspect of the present invention, there is provided a method comprising comparing, at telecommunications network equipment, a prefix of an IPv6 address of a first endpoint with a prefix of an IPv6 address of a second endpoint to determine whether or not to attempt media bypass between the first and second endpoints.

According to a fourth aspect of the present invention, there is provided a method comprising performing, at telecommunications network equipment, prefix-matching of first and second IP addresses of first and second endpoints respectively to determine whether or not to enable media bypass for a media communications session involving both the first and second endpoints.

According to a fifth aspect of the present invention, there is provided a method comprising determining, at telecommunications network equipment, whether to include a first endpoint identifier associated with a first endpoint or an identifier associated with a media relay in session description protocol information transmitted to a second endpoint associated with a second endpoint identifier based on whether or not the first and second endpoint identifiers have one or more predetermined endpoint identifier portions in common.

According to a sixth aspect of the present invention, there is provided telecommunications network equipment configured to perform a method according to the method provided according to any of the first to fifth aspects of the present invention.

According to a seventh aspect of the present invention, there is provided a computer program comprising instructions which, when executed, cause telecommunications network equipment to perform a method according to the method provided according to any of the first to fifth aspects of the present invention.

Further features and advantages will become apparent from the following description, given by way of example only, which is made with reference to the accompanying drawings.

### BRIEF DESCRIPTION OF THE DRAWINGS

FIG. 1 shows a schematic block diagram of an example of a telecommunications network in accordance with embodiments;

FIG. 2 shows a sequence diagram illustrating an example of a method in accordance with embodiments; and

FIG. 3 shows a sequence diagram illustrating another example of a method in accordance with embodiments.

### DETAILED DESCRIPTION OF CERTAIN INVENTIVE EMBODIMENTS

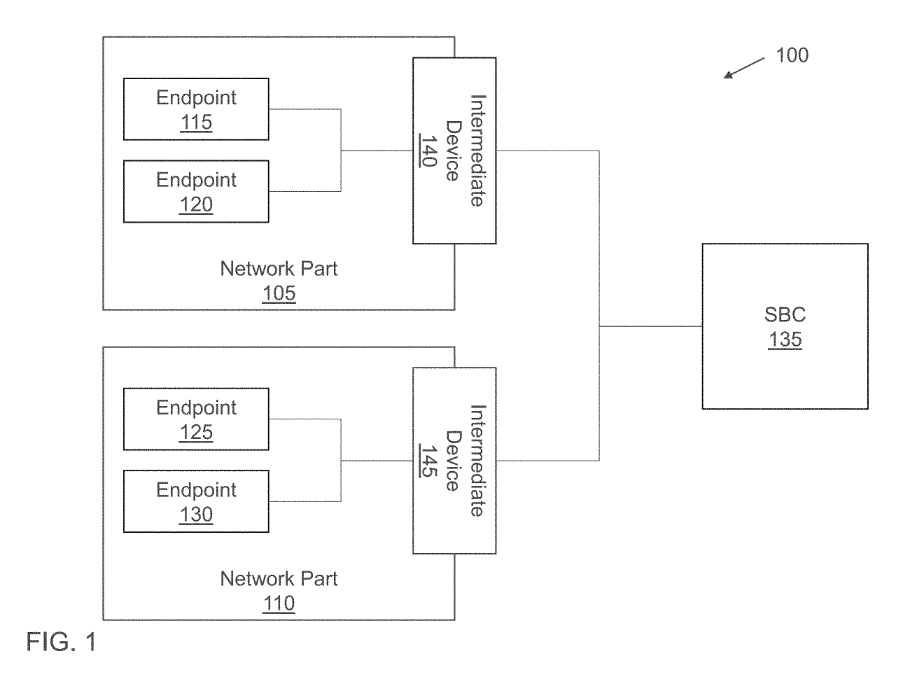

Referring to FIG. 1, there is shown an example of a telecommunications network 100.

In this example, the telecommunications network 100 comprises first and second network parts 105, 110. The first and second network parts 105, 110 are logically separate parts of the telecommunications network 100. The first and second network parts 105, 110 may be local to or remote from each other in the telecommunications network 100. The first and second network parts 105, 110 may be associated with the same or different entities, for example businesses. The telecommunications network 100 may comprise more than two different network parts.

In this example, the first network part 105 comprises two endpoints 115, 120 and the second network part 110 comprises two endpoints 125, 130. The telecommunications network 100 may comprise a different number and/or arrangement of endpoints.

In this example, each of the endpoints 115, 120, 125, 130 is a user device. Examples of user device include, but are not limited to, desktop telephones, mobile telephones, laptop computing devices and tablet computing devices.

In this example, each of the endpoints 115, 120, 125, 130 is associated with a respective endpoint identifier. An endpoint identifier identifies the endpoint with which it is associated in at least part of the telecommunications network 100 and/or in another network.

An example of an endpoint identifier is an IP address. An IP address may be used to identify a network interface of a host in an IP network. Examples of IP addresses include, but are not limited to, IP version 4 (IPv4) addresses and IP version 6 (IPv6) addresses. An IP address (whether IPv4 or IPv6) is valid and unique within the IP network of which it is part. Another example of an endpoint identifier is a telephone number.

IPv4 and IPv6 addresses may be used to identify network interfaces of hosts in IPv4 and IPv6 networks respectively. IPv4 and IPv6 addresses are 32-bit and 128-bit values respectively. An example format of an IPv4 address is ‘a.a.a.a’ where ‘a’ is an octet having a decimal value between 0 to 255 inclusive. The octets ‘a’ can all have the same values as each other, or some or all of the octets ‘a’ can have different values. An example format of an IPv6 address is ‘b:b:b:b:b:b:b:b’, where ‘b’ is a segment having a hexadecimal value between 0 and FFFF. The segments ‘b’ can all have the same values as each other, or some or all of the segments ‘b’ can have different values.

The first and second network parts 105, 110 may correspond to different subnetworks (also known as ‘subnets’) of the telecommunications network 100. Both IPv4 and IPv6 networks can be divided into subnets. An IP address may be considered to have two different portions, namely a network prefix and a host identifier (also known as an ‘interface identifier’ in IPv6). Hosts belonging to the same subnet share the same network prefix but have different host identifiers. Different subnets can have different sizes. The size of the subnet can be given in the format ‘/X’ where ‘X’ indicates the number of bits at the start of the IP address (in other words, the ‘prefix size’ or ‘number of most significant bits’) that comprise the network prefix. For example, for an IPv6 network, ‘/64’ indicates that the first sixty-four bits of the IPv6 address indicate the network prefix and the remaining sixty-four bits indicate the host identifier. Two IPv6 addresses sharing the same first sixty-four bits as each other belong to the same subnet.

In this example, the telecommunications network 100 also comprises telecommunications network equipment 135. In this example, the telecommunications network equipment 135 is in neither the first network part 105 nor the second network part 110. The telecommunications network 100 may comprise one or more processors and one or more memories. One or more computer programs comprising computer-readable instructions may be stored in the one or more memories. The one or more processors may be configured to execute the computer-readable instructions and perform at least some of the methods and techniques described herein as a result.

For convenience and brevity, in the specific examples described in more detail below, the telecommunications network equipment 135 is typically an SBC, it being understood that the telecommunications network equipment 135 may comprise multiple SBCs and also that the telecommunications network equipment 135 may not be an SBC. For example, the telecommunications network equipment 135 may be a signalling gateway or a Session Initiation Protocol (SIP) proxy. A SIP proxy may be comprised in an IP Private Branch Exchange (IP PBX).

In this example, the telecommunications network 100 comprises first and second intermediate devices 140, 145, which are associated with the first and second network parts 105, 110 respectively. The first intermediate device 140 is intermediate the SBC 135 and the endpoints 115, 120 in the first network part 105 and the second intermediate device 140 is intermediate the SBC 135 and the endpoints 125, 130 in the second network part 110. Some or all data (for example signalling and/or media data) communicated between the endpoint 115 and the SBC 135 and some or all data communicated between the endpoint 120 and the SBC 135 passes through the first intermediate device 140. Some or all data communicated between the endpoint 125 and the SBC 135 and some or all data communicated between the endpoint 130 and the SBC 135 passes through the second intermediate device 145.

In the examples describes herein, the first and second intermediate devices 140, 145 provide firewall functionality. Firewall functionality may comprise monitoring incoming and/or outgoing data based on one or more predetermined security rules. As such, a device providing firewall functionality may serve to act as a barrier between one network (or network part) and another network (or network part). In the specific examples described herein, the first and second intermediate devices 140, 145 provide firewall functionality that prevents the endpoints 115, 120 in the first network part 105 from sending media data directly to the endpoints 125, 130 in the second network part 110.

The first and second intermediate devices 140, 145 may provide network address translation (NAT) functionality. NAT may take place when an IP datagram packet (incoming or outgoing) traverses the NAT device and may comprise replacing one IP address with another IP address. A NAT device may map multiple private IP addresses of endpoints in a private network to one public IP address of the NAT device. The NAT device may have a private IP address in the private network. The NAT device may replace a private IP address of an endpoint in a private network with the public IP address of the NAT for outgoing IP datagram packets from the endpoint and may replace the public IP address of the NAT device with the private IP address of the endpoint for incoming IP datagram packets to the endpoint. The NAT device may store tracking data to enable the NAT device to determine which of multiple endpoints in the private network incoming IP datagram packets should be passed to. The NAT device may map a given private IP address of a given endpoint in a private network to a particular public IP address and port combination in outgoing IP datagram packets so that incoming IP datagram packets to that public IP address and port combination can be provided to the given endpoint in the private network. NAT devices are relatively common in IPv4 networks, but are less common in IPv6 networks. For example, some IPv6 networks do not comprise NAT devices.

In this specific example, the first and second intermediate devices 145, 150 do not provide NAT functionality. Further, in this specific example, the endpoints 115, 120, 125, 130 all have respective IPv6 addresses.

Examples will now be described relating to small and medium-sized businesses (SMBs), it being understood that the features described herein are not limited to use in the context of SMBs and may be used in the context of any type of entity. In these examples, all endpoints associated with a given SMB are in a common subnet and have the same size set of addresses. In particular, a given SMB is allocated a set of IPv6 addresses with a common prefix. For example, all endpoints associated with the given SMB may share the same /64 IPv6 prefix, in other words the first sixty-four bits of the IPv6 addresses of each endpoint associated with the given SMB is the same. This means that the SMB would be able to use 2¹²⁸⁻⁶⁴=264 different host identifiers. Other SMBs are allocated respective sets of IPv6 addresses with respective common prefixes. In these examples, all SMBs have the same network prefix size, namely /64. As such, all endpoints associated with a given SMB have the same /64 prefix as each other, but different SMBs have different /64 prefixes. A service provider or operator may allocate each SMB customer with a standard range of IPv6 addresses.

An entity may be allocated a set of IPv6 addresses with a prefix size that is different from sixty-four. For example, a large business may be allocated a set of IPv6 addresses with a prefix size of 56 (in other words a /56 prefix), meaning that the large business would be able to use 2¹²⁸⁻⁵⁶=2⁷² different host identifiers. A home user may be allocated a set of IPv6 addresses with a prefix size of 126 (in other words a /126 prefix), meaning that the home user would be able to use 2¹²⁸⁻¹²⁶=2² different host identifiers.

In examples described below, the SBC 135 is configured to automatically attempt to bypass media between endpoints that share the same IPv6 prefix (for example a /64 prefix). Endpoints in the same SMB (in other words intra-SMB endpoints) may be enabled to send media directly to each other, while media bypass may not be attempted where one of the endpoints is outside the SMB, for example on the basis that such an attempt will likely fall foul of one or more firewall rules without an external media relay.

Further, in accordance with examples described herein, the SBC 135 can be configured, for all traffic on a given port, to attempt media bypass between any endpoints sharing a common prefix (for example a /64 prefix). All SMBs may be configured to use that one port of the SBC 135. In other words, the /64 prefix may be used for all traffic received on the given port, on the basis that the only traffic received on that port relates to SMB endpoints and all SMBs have a /64 prefix. If traffic relating to entities with different sized prefixes were received in the same port, handling of such traffic by the SBC 135 may involve determining the size of the prefix associated with the entity to which the traffic relates which may result in increased complexity. References herein to a “port” of the SBC 135 will be understood to be to a logical port of the SBC 135. For example, an operator may use different IP addresses to create different logical ports. For instance, small businesses may be provisioned to connect to one logical port such as <IP1>:5060 and medium businesses may be provisioned to connect to a different logical port, such as <IP2>:5060. 5060 is traditionally used for SIP.

Although the examples described below are especially effective for SMBs, they are not limited to use in relation to SMBs. In particular, the techniques described herein may still be effective in relation to larger sized business (or other types of entity altogether) where all endpoints associated with a given larger business all have the same size set of addresses, but this is believed to be less common for larger businesses than for SMBs.

Examples described herein can enhance efficiency for an operator offering services to a large number (for example hundreds) of SMBs and/or to any entities for which IP addresses are allocated as a contiguous block of IP addresses. Such efficiency can come from making each such SMB offering a ‘cookie-cutter’ offering. The more bespoke work involved in such an offering, per-SMB, the lower the efficiency. A more bespoke offering may, for example, involve creating a unique realm-ID for every SMB, provisioning that unique realm-ID on the SMB's equipment, and provisioning that unique realm-ID on the SBC 135. In contrast, examples described herein may not involve additional per-SMB bespoke provisioning.

Although discontiguous block allocation is not prevented in IPv6, operators providing IPv6 access to their SMB customers are likely to follow the ‘cookie-cutter’ principle described above, such that each SMB is allocated the same size block of IPv6 addresses. SMBs will likely be allocated a single, contiguous block of IPv6 addresses and retain that IP address block for a lengthy period of time. An SMB may be able to request additional blocks of IPv6 addresses, but this is likely to be the exception rather than the norm. In such cases, more bespoke provisioning, for example using realm-IDs, may however be used. Examples described herein provide an efficient solution for scenarios in which IP addresses are grouped together on a “one subnet, one owner” basis, which are likely to be the majority of scenarios. Although this may result in an efficiency trade-off, the majority of SMBs are likely to be better served by the examples described herein. Exceptions may, for example, use indirect media communication and/or have bespoke arrangements in place. As such, the efficiency gains outweigh the possible implications associated with the limited scenarios in which one owner has several subnets.

Examples described herein can leverage knowledge of the block size to identify where media bypass should and should not be attempted. As such, instead of provisioning a separate item (such as a realm-ID) for every SMB, the size of the block may be provisioned only once.

Further, as described above, operators may offer different block sizes. For example, a small business may be allocated 64 IP addresses, a medium business may be allocated 128 IP addresses, etc. All small businesses may be provisioned to connect to one logical port of the SBC 135, and all medium businesses may be provisioned to connect to a different logical port of the SBC 135. As such, there may be a setup phase for a given business in which it is determined which logical port of the SBC 135 the business should connect to. This can be based on the size of the business and, therefore, the prefix size. This can provide an efficient way to segregate traffic from different-sized businesses as described herein.

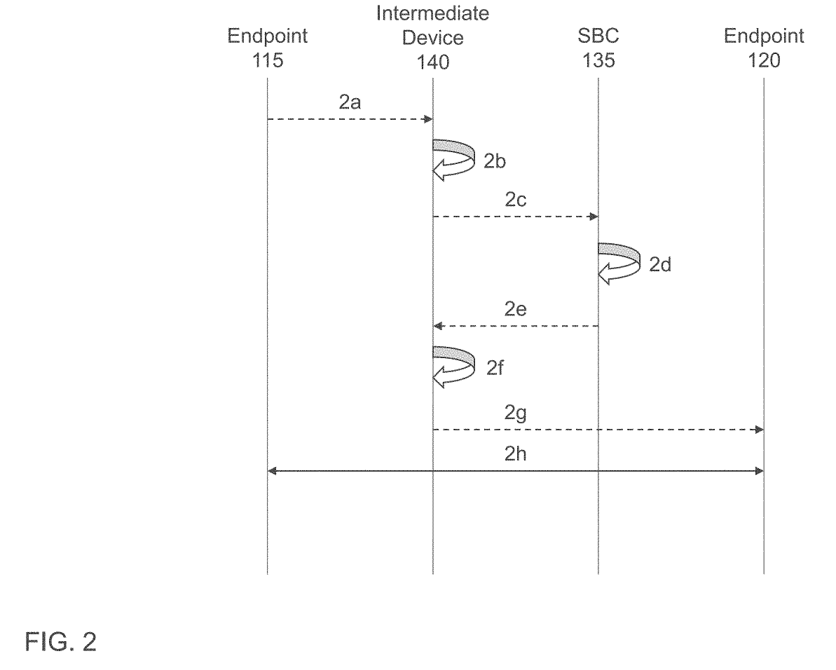

Referring to FIG. 2, there is shown an example of a method. The method may be performed in the telecommunications network 100 of FIG. 1 or otherwise.

In this example, a user of a first endpoint, endpoint 115, in the first network part 105 wishes to conduct communications with a user of a second endpoint, endpoint 120, which is also in the first network part 105. The user of the first endpoint 115 may initiate such communications in various different ways, for example by selecting the user of the second endpoint 120 in an address book on the first endpoint 115.

At item 2a, the first endpoint 115 transmits signalling associated with establishment of a media communications session involving the first endpoint 115 and the second endpoint 120 to the first intermediate device 140. The signalling may, for example, comprise a SIP INVITE message. The signalling comprises a first endpoint identifier associated with the first endpoint 115 and a further endpoint identifier associated with the second endpoint 120. The first endpoint identifier corresponds to a calling party identifier (also referred to as a ‘source identifier’ or ‘source address’) and the further endpoint identifier corresponds to a called party identifier (also referred to as a ‘destination identifier’ or ‘destination address’). In this example, the first endpoint identifier comprises the IPv6 address of the first endpoint 115 and the further endpoint identifier comprises a telephone number of the second endpoint 120. In other examples, where the first endpoint 115 has the IPv6 address of the second endpoint 120, the further endpoint identifier could comprise the IPv6 address of the second endpoint 120.

At item 2b, the first intermediate device 140 receives and processes the signalling of item 2a. In this example, the first intermediate device 140 comprises firewall functionality but not NAT functionality. As such, the first intermediate device 140 processes the signalling of item 2a in accordance with one or more predetermined security rules.

At item 2c, the first intermediate device 140 transmits signalling based on the signalling of item 2a to the SBC 135.

At item 2d, the SBC 135 receives and processes the signalling of item 2c.

As such, the received signalling of item 2c has traversed a first signalling path between the first endpoint 115 and the SBC 135, where the first signalling path does not comprise a NAT device but does comprise a firewall.

Further, the received signalling of item 2c is associated with the establishment of a media communications session involving the first and second endpoints 115, 120 and comprises the first and further endpoint identifiers associated with the first and second endpoints 115, 120, namely, in this example, the IPv6 address of the first endpoint 115 and the telephone number of the second endpoint 120 respectively.

Since, in this example, the further endpoint identifier comprises the telephone number of the second endpoint 120 and not the IPv6 address of the second endpoint 120, the SBC 135 transmits signalling based on the signalling of item 2c to the core network (not shown). The core network looks up the IPv6 address of the second endpoint 120 using the telephone number of the second endpoint 120 and returns the IPv6 address of the second endpoint 120 to the SBC 135. Where the further endpoint identifier comprises the IPv6 address of the second endpoint 120, the SBC 135 may not transmit such signalling to the core network.

As such, the SBC 135 has identified, based on the received signalling of item 2c, first and second endpoint identifiers associated with the first and second endpoints 115, 120 respectively, where the first endpoint identifier comprises the IPv6 address of the first endpoint 115 and the second endpoint identifier comprises the IPv6 address of the second endpoint 120. In this specific example, the SBC 135 obtains the second endpoint identifier using the further endpoint identifier comprised in the received signalling of item 2c.

The processing at 2d also involves the SBC 135 determining whether or not to attempt media bypass between the first and second endpoints 115, 120 based on a comparison involving a first portion of the first endpoint identifier, in this example the IPv6 address of the first endpoint 115, and a second portion of the second endpoint identifier, in this example the IPv6 address (and not the telephone number) of the second endpoint 120.

The size of the first portion is the same as the size of the second portion. The size of the first and second portions may, for example, be sixty-four bits. This could be the case where the SBC 135 is configured to use a /64 prefix for all traffic received on a given (logical) port of the SBC 135.

The comparison performed by the SBC 135 involves only part of the first endpoint identifier and only part of the second endpoint identifier. In other words at least part of the first endpoint identifier and at least part of the second endpoint identifier is not used in the comparison. If the comparison involved using the entire first endpoint identifier and the entire second endpoint identifier then the comparison would only result in a match when the first and second endpoint identifiers were the same as each other. Comparing an entire calling party IP address to an entire called party IP address may be effective where a NAT device is present, on the basis that that the calling and called party IP addresses being the same implies that the calling and called party endpoints are both behind the NAT device and therefore that media bypass may be supported. However, in other cases, comparing an entire calling party IP address to an entire called party IP address may only result in a match when, in effect, a calling party endpoint was attempting to call itself.

The SBC 135 may comprise a plurality of ports. The SBC 135 may determine the size of the first portion and the size of the second portion based on which one of the plurality of ports receives the signalling. For example, the SBC 135 may determine that a first given size is to be used for the first and second portions where the signalling is received on a first port and may determine that a second given size is to be used for the first and second portions where the signalling is received on a second port.

The first and second given sizes may be the same. As such, the SBC 135 can provide multiple different ports for use by, for example, SMBs which may all have a /64 prefix.

The first and second given sizes may be different. As such, the SBC 135 can provide multiple different ports for use by, for example, SMBs and larger business respectively which may have /64 and /56 prefixes respectively.

The location of the first portion in the first endpoint identifier may be the same as the location of the second portion in the second endpoint identifier. For example, the first portion may be a prefix of the first endpoint identifier and the second portion may be a prefix of the second endpoint identifier.

A result of the comparison may be indicative of whether or not the first and second endpoints 115, 120 can communicate media data directly with each other. For example, the result of the comparison may be indicative of whether or not the first and second endpoints 115, 120 are in a common subnet. The SBC 135 may be configured to attempt media bypass between the first and second endpoints 115, 120 when the result of the comparison indicates that the first and second endpoints 115, 120 can communicate media data directly with each other. For example, it may be assumed that the first and second endpoints 115, 120 support media bypass between each other when the first and second endpoints 115, 120 are in a common subnet.

In this example, the SBC 135 determines that media bypass is to be attempted between the first and second endpoints 115, 120. In response to this determination, the SBC 135 attempts to cause media data for the media session to be communicated directly between the first and second endpoints 115, 120. It should be noted that the attempt by the SBC 135 to cause media data for the media session to be communicated directly between the first and second endpoints 115, 120 may not succeed. For example, the SBC 135 may infer that the first and second endpoints 115, 120 support media bypass between each other based on the above-mentioned comparison but media bypass may not, in fact be supported. One or more predetermined actions may be performed in such an event. An example of such a predetermined action is the SBC 135 falling back to indirect media data communication between the first and second endpoints 115, 120 where, for example, such media data is communicated via a media relay which may or may not be comprised in the SBC 135. Another example of such a predetermined action is the SBC 135 causing the media session not to be established.

In the context of IPv4 addresses, the first and second network parts 105, 110 can be associated with NAT functionality and the SBC 135 could attempt media bypass for any endpoints that are determined to be behind the same NAT device, on the basis that each NAT device is assumed to have only one IPv4 address. In IPv6 the same technique may not be effective, since NAT devices may not be used in IPv6. Where a NAT device is not used in an IPv6 network, the SBC 135 cannot use the IP address of the NAT device to determine whether or not to attempt media bypass.

At item 2e, the SBC 135 transmits signalling based on the signalling of item 2c to the first intermediate device 140. The SBC 135 transmits the signalling of item 2e to the first intermediate device 140 rather than to the second intermediate device 145 since the second endpoint 120 is in the first network part 105 which is behind the first intermediate device 140. The signalling of item 2e is associated with the establishment of the media communications session involving the first and second endpoints 115, 120 and comprises the first and second endpoint identifiers.

At item 2f, the first intermediate device 140 receives and processes the signalling of item 2e. Since, in this example, the first intermediate device 140 comprises firewall functionality but not NAT functionality, the first intermediate device 140 processes the signalling of item 2e in accordance with one or more predetermined security rules associated with the first network part 105.

At item 2g, the first intermediate device 140 transmits signalling based on the signalling of item 2f to the second endpoint 120.

As such, the received signalling of item 2g has traversed a second signalling path between the SBC 135 and the second endpoint 120, where the second signalling path does not comprise a NAT device but does comprise a firewall.

At item 2h, direct media is established between the first and second endpoints 115, 120. Media data can thereby be communicated directly between the first and second endpoints 115, 120. In this example, such media data is not communicated via the first intermediate device 140 and/or the SBC 135.

In order to enable media bypass, the SBC 135 can ensure that the Session Description Protocol (SDP) information associated with the media communications session provides the IPv6 address of the first endpoint 115 to the second endpoint 120 such that the second endpoint 120 can transmit media data to and receive media data from the IPv6 address of the first endpoint 115, and not to and from an IP address of the SBC 135 or another media relay. Similarly, the SBC 135 can ensure that the SDP information associated with the media communications session provides the IPv6 address of the second endpoint 120 to the first endpoint 115 such that the first endpoint 115 can transmit media data to and receive media data from the IPv6 address of the second endpoint 120, and not to and from an IP address of the SBC 135 or another media relay.

One or more further actions may be performed between items 2g and 2h, for example transmission of one or more acknowledgement messages and/or transmission of one or more acceptance messages.

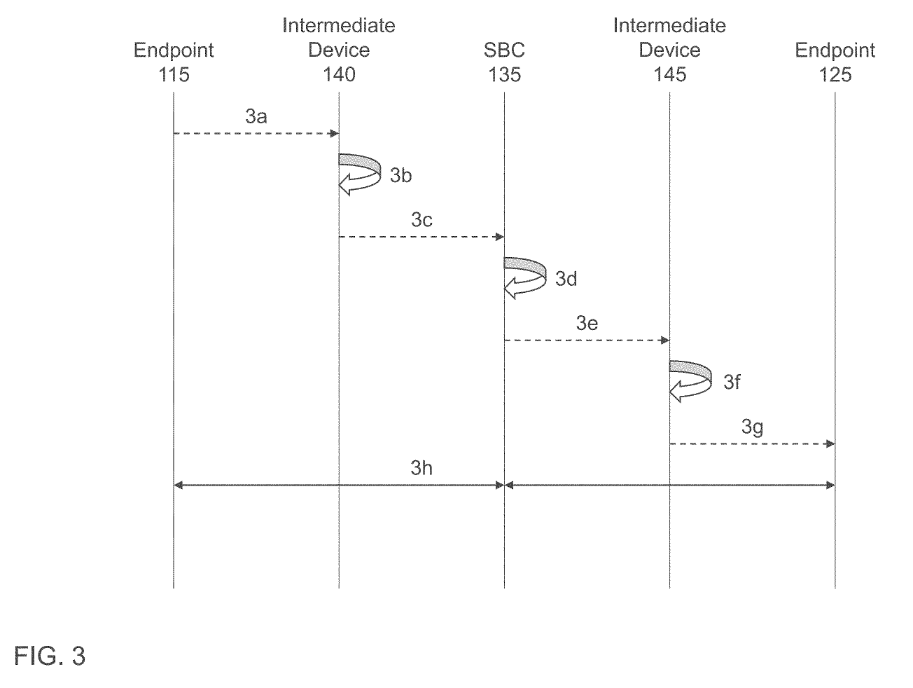

Referring to FIG. 3, there is shown an example of a method. The method may be performed in the telecommunications network 100 of FIG. 1 or otherwise.

In this example, a user of a first endpoint, endpoint 115, in the first network part 105 wishes to conduct communications with a user of a second endpoint, endpoint 125, which is in the second network part 110.

Items 3a to 3c correspond closely to items 2a to 2c described above, except that the first and further endpoint identifiers are associated with endpoints 115 and 125 respectively rather than endpoints 115 and 120.

Item 3d also corresponds closely to item 3c described above in that the SBC 135 receives and processes the signalling of item 3c.

However, in this example, while the SBC 135 determines whether or not to attempt media bypass between the first and second endpoints 115, 125 based on a comparison involving a first portion of the first endpoint identifier (in this example the IPv6 address of the first endpoint 115) and a second portion of the second endpoint identifier (in this example the IPv6 address of the second endpoint 125), the SBC 135 determines that media bypass is not to be attempted between the first and second endpoints 115, 125.

In response to determining that media bypass is not to be attempted between the first and second endpoints 115, 125, the SBC 135 performs a predetermined action. In this example, the SBC 135 performs the predetermined action by enabling media data for the media session to be relayed between the first and second endpoints 115, 125 via a media relay. The media relay is different from the first and second endpoints 115, 125. The media relay may be comprised in the SBC 135. Alternatively, the media relay may not be comprised in the SBC 135 or may not be comprised in another type of telecommunications network equipment where the telecommunications network equipment 135 is not an SBC (for example if the telecommunications network equipment 135 is a signalling gateway).

As such, at item 3e, the SBC 135 transmits signalling based on the signalling of item 3c to the second intermediate device 145. The SBC 135 transmits the signalling of item 3e to the second intermediate device 145 rather than to the first intermediate device 140 since the second endpoint 125 is in the second network part 110 which is behind the second intermediate device 145.

At item 3f, the second intermediate device 145 receives and processes the signalling of item 3e. Since, in this example, the second intermediate device 145 comprises firewall functionality but not NAT functionality, the second intermediate device 145 processes the signalling of item 3e in accordance with one or more predetermined security rules associated with the second network part 110.

At item 3g, the second intermediate device 145 transmits signalling based on the signalling of item 3f to the second endpoint 125.

At item 3h, a media session is established between the first and second endpoints 115, 125.

In this example, since media bypass has not been enabled, the SBC 135 provides its own IP address or an IP address of another media relay to both the first and second endpoints 115, 125 to indicate to the first and second endpoints 115, 125 that media data should be transmitted to and received from the SBC 135 or the other media relay as appropriate.

One or more further actions may be performed between items 3g and 3h, for example transmission of one or more acknowledgement messages and/or transmission of one or more acceptance messages.

The above embodiments are to be understood as illustrative examples. Further embodiments are envisaged.

In examples described above, the endpoints identifiers comprise IP addresses. In other examples, instead of using, for example, an IPv6 prefix, a standardised range of telephone numbers could be used in relation to each network part (for example on a per-SMB basis). As such, media bypass could be attempted for all calls within the standardised range. However, this may involve manual configuration of the telephony network equipment 135 to store the range of telephone numbers associated with each network part. In addition, such an example may not be effective in the case of mobile telephone numbers where calls could be made using a mobile telephone number outside of standardised range allocated to a particular SMB.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of controlling telecommunications network equipment, the method comprising:
receiving signalling associated with establishment of a media communications session involving first and second endpoints;
identifying a first endpoint identifier associated with the first endpoint and a second endpoint identifier associated with the second endpoint based on the signalling;
determining whether or not to attempt media bypass between the first and second endpoints based on a comparison involving a first portion of the first endpoint identifier and a second portion of the second endpoint identifier; and
in response to determining that media bypass is to be attempted between the first and second endpoints, attempting to cause media data for the media session to be communicated directly between the first and second endpoints.

2. The method of claim 1, wherein the first endpoint identifier and/or the second endpoint identifier comprises an Internet Protocol, IP, address.

3. The method of claim 1, wherein the first endpoint identifier and/or the second endpoint identifier comprises an Internet Protocol version 6, IPv6, address.

4. The method of claim 1, wherein a result of said comparison is indicative of whether or not the first and second endpoints can communicate media data directly with each other.

5. The method of claim 4, wherein the result of said comparison is indicative of whether or not the first and second endpoints are in a common subnet.

6. The method of claim 1, wherein the size of the first portion is the same as the size of the second portion.

7. The method of claim 1, wherein the telecommunications network equipment comprises a plurality of ports and wherein the method comprises determining the size of the first portion and the size of the second portion based on which one of the plurality of ports receives the signalling.

8. The method of claim 1, wherein the first portion is a prefix of the first endpoint identifier and the second portion is a prefix of the second endpoint identifier.

9. The method of claim 1, wherein the received signalling traverses a first signalling path, the first signalling path being between the first endpoint and the telecommunications network equipment, and wherein the first signalling path does not comprise a network address translation device.

10. The method of claim 9, wherein the first signalling path comprises a firewall.

11. The method of claim 1, comprising transmitting signalling associated with the establishment of the media communications session involving the first and second endpoints, the transmitted signalling comprising the first and second endpoint identifiers.

12. The method of claim 11, wherein the transmitted signalling traverses a second signalling path, the second signalling path being between the telecommunications network equipment and the second endpoint, and wherein the second signalling path does not comprise a network address translation device.

13. The method of claim 12, wherein the second signalling path comprises a firewall.

14. The method of claim 1, comprising, in response to determining that media bypass is not to be attempted between the first and second endpoints, enabling media data for the media session to be relayed between the first and second endpoints via a media relay.

15. The method of claim 14, wherein the media relay is comprised in the telecommunications network equipment.

16. The method of claim 1, wherein said comparison involves only part of the first endpoint identifier and only part of the second endpoint identifier.

17. The method of claim 1, wherein attempting to cause media data for the media session to be communicated directly between the first and second endpoints comprises providing the first endpoint identifier to the second endpoint and providing the second endpoint identifier to the first endpoint.

18. The method of claim 1, wherein the telecommunications network equipment is:
a signalling gateway;
a session border controller; or
a Session Initiation Protocol, SIP, proxy.

19. A method comprising:
comparing, at telecommunications network equipment, a prefix of an IPv6 address of a first endpoint with a prefix of an IPv6 address of a second endpoint; and
determining, at the telecommunications network equipment, whether or not to attempt media bypass between the first and second endpoints based on a result of said comparing.

20. A method of controlling telecommunications network equipment, the method comprising:
receiving signalling associated with establishment of a media communications session involving first and second endpoints;
identifying a first IPv6 address associated with the first endpoint and a second IPv6 address associated with the second endpoint based on the received signalling associated with the establishment of the media communications session involving the first and second endpoints;
determining whether or not to attempt media bypass between the first and second endpoints based on a result of a comparison involving a first portion of the first IPv6 address and a second portion of the second IPv6 address, wherein the result of the comparison indicates whether or not the first and second endpoints are in a common subnet; and
in response to determining, based on the result of the comparison involving the first and second portions of the first and second IPv6 addresses indicating that the first and second endpoints are in the common subset, that media bypass is to be attempted between the first and second endpoints, attempting to cause media data for the media session to be communicated directly between the first and second endpoints.
